(19) United States
(12) Patent Application Publication
(10) Pub. No.: US 2006/0180002 A1
(43) Pub. Date: Aug. 17, 2006

(54) Button structure of saxophone

(76) Inventor: Wei-Fu Lin, Fengyuan City (TW)

Correspondence Address: RABIN & BERDO, P.C.;Suite 500, 1101 14 Street, N.W., Washington, DC, 20005, US

(21) Appl. No.: 11/058,268

(22) Filed: Feb. 16, 2005

(51) Int. Cl. G10D 7/08; G10D 9/04; G10D 9/00

(52) U.S. Cl. 84/385 R

(57) ABSTRACT

A button structure of saxophone modifying the shapes of the G♯ button, the bass B button, the bass C♯ button and the tongue shape Bb button; in order to match up the curve of the long round bar above the tongue shape Bb button, the centers of the surface of the G♯ button, the bass B button and the bass C♯ button are made to be the highest point then descend smoothly to the rim in curve shape; based on above description, the surfaces of these buttons are in curve shape to increase the contact area between finger and buttons, reduce the level and distant difference, and offers better performance to the players, the outlook of buttons are more harmonious with the whole saxophone.

### BACKGROUND OF THE INVENTION

I. Field of the Invention

This invention relates generally to a button structure and, more specifically, to a button structure of saxophone that modifies the shape of G♯ button, bass B button and bass C♯ button, not only increases the contact area between finger and the surface of buttons, but also reduces the level and distant difference, and offers better performance of the players, the outlook of buttons are more harmonious with the whole saxophone.

II. Description of the Prior Art

Heretofore, it is known that the play of current saxophones is to have players' left little fingers to operate G♯ button, bass B button, bass C♯ button and tongue shape Bb button for corresponding sound.

Referring to FIG. 1 and FIG. 1A, that shows the arrangement of these buttons, they are G♯ button a, bass B button b, bass C♯ button c and tongue shape Bb button d, a long round bar d1 is on top of the tongue shape Bb button d that is located on the lowest bottom, a bend d2 raising upward slightly is above the long round bar d1; most of the G♯ button a, bass B button b, bass C♯ button c are in flat shape, a decoration a1 are installed on the center of G♯ button a, such are made of seashell or plastic material to increase touch feeling and to lower the location difference by a single metal button; the above buttons are all in the same plane and form a definite angle with left little finger, these buttons are in close range for rapid button switch, such causes level difference while switching buttons that is not very smooth for players.

The present invention modifies the outer shape of these buttons to increase the contact area of finger for the flexibility of players, regardless player' finger is on the center of the buttons, the pushing strength of finger is transmitted to the joint rod to reduce the level difference during playing for better play performance.

### SUMMARY OF THE INVENTION

It is therefore a primary object of the invention to provide a button structure of saxophone that increases the contact area between finger and the surface of buttons, reduces the level and distant difference, and offers better performance of the players, the outlook of buttons are more harmonious with the whole saxophone.

In order to achieve the objective set forth, a button structure of saxophone in accordance with the present invention, the present invention modifies the shapes of the G♯ button, the bass B button, the bass C♯ button and the tongue shape Bb button; in order to match up the curve of the long round bar above the tongue shape Bb button, the centers of the surface of the G♯ button, the bass B button and the bass C♯ button are made to be the highest point then descend smoothly to the rim in curve shape.

Based on above description, the surfaces of these buttons are in curve shape to increase the contact area between finger and buttons, players can play smoother; by mechanics, the curve surface design turns the physical strength direction to the center of the circle, regardless player' finger is on the center of the buttons or not, the pushing strength of finger is transmitted to the joint rod to reduce the level difference during playing for better play performance.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the prior art;

FIG. 1A is a cross-sectional view of the prior art;

FIG. 2 is a perspective view of the present invention;

FIG. 2A is a cross-sectional view of the present invention.

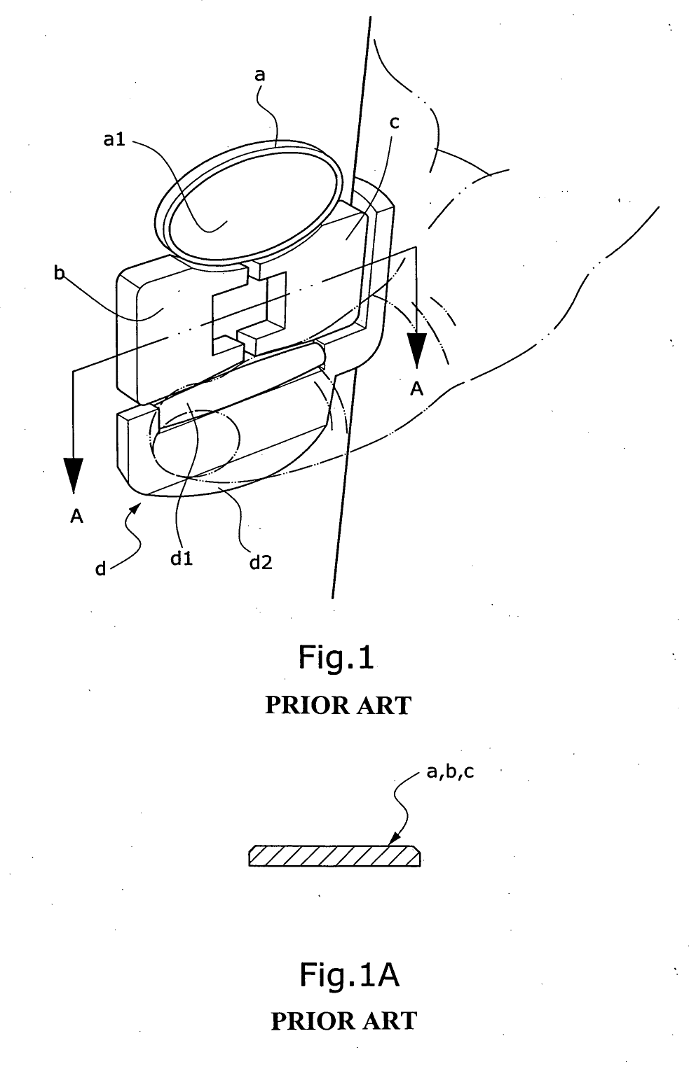

### DESCRIPTION OF THE PREFERRED EMBODIMENT

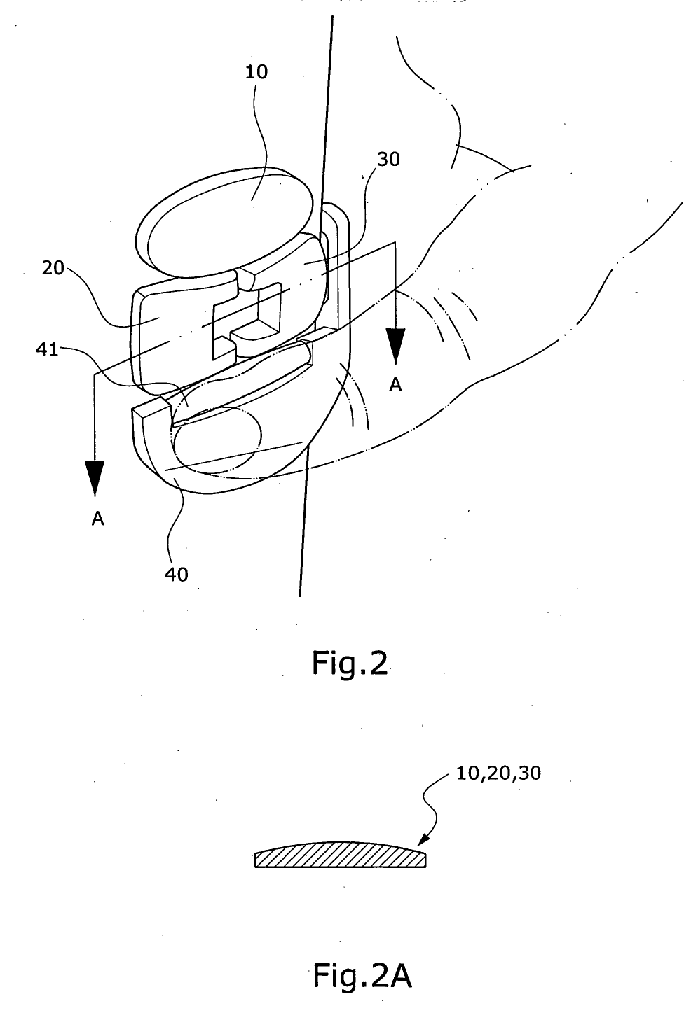

Referring to FIG. 2 and FIG. 2A, the present invention modifies the shapes of the G♯ button 10, the bass B button 20, the bass C♯ button 30 and the tongue shape Bb button 40; in order to match up the curve of the long round bar 41 above the tongue shape Bb button 40, the centers of the surfaces of the G♯ button 10, the bass B button 20 and the bass C♯ button 30 are design to be the highest point then descend smoothly to the rim in curve shape.

Based on above description, the surfaces of these buttons are in curve shape to increase the contact area between finger and button, reduce the level and distant difference, and offers better performance to the players, the outlook of buttons are more harmonious with the whole saxophone.

While a preferred embodiment of the invention has been shown and described in detail, it will be readily understood and appreciated that numerous omissions, changes and additions may be made without departing from the spirit and scope of the invention.

What is claimed is:

1. A button structure of saxophone:
the shape of the G♯ button, the bass B button and the bass C♯ button are modified, in order to match up the curve of the long round bar above the tongue shape Bb button, the centers of the surface of said G♯ button, said bass B button and said bass C♯ button are made to be the highest point then descend smoothly to the rim in curve shape.
